(19) United States
(12) Patent Application Publication
(10) Pub. No.: US 2009/0002353 A1
(43) Pub. Date: Jan. 1, 2009

(54) DISPLAY APPARATUS AND DRIVE METHOD THEREOF

(75) Inventor: MASAKUNI YAMAMOTO, Yamato-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/141,647

(22) Filed: Jun. 18, 2008

(30) Foreign Application Priority Data
Jun. 27, 2007 (JP) 2007-169074

(51) Int. Cl. G06F 3/038; G09G 3/34

(52) U.S. Cl. 345/204; 345/84; 348/739

(57) ABSTRACT

A display apparatus including a display having an upper display part and a lower display part, comprises a frame memory for storing therein the video image data at a rate of N frames/sec and supplying the stored video image data twice to each of the upper display part and the lower display part to write the video image data into the display at a rate of 2N frames/sec, wherein while the video image data of the (I+1)th frame are written in the upper display part as the first time, the video image data of Ith frame preceding by one frame to the (I+1)th frame is written in the lower display part as the second time, and while the video image data of (I+1)th frame are written in the upper display part as the second time, the video image data of the (I+1)th frame are written in the lower display part as the first time.

### BACKGROUND OF THE INVENTION

1. Field of the Invention

The present invention relates to a display apparatus for displaying images and a method thereof and, in particular, to a matrix-type display apparatus, a screen of which is vertically split into two portions.

2. Description of the Related Art

A cathode ray tube (CRT) that brings electrons into collision with a phosphor on a screen with an electron gun to make the phosphor to emit light using the collision energy has technological advantages in display quality and cost, so that the CRT has been used as a display for a television set, a personal computer and the like for a long time.

In recent years, researches and developments have been made on flat panel displays (FPD) with higher priority given to space saving, convenience and portability than heavy and bulky CRTs and the flat panel displays have been commercialized. The FPD includes a non-light emitting type liquid crystal display, a self light emitting type plasma display (PD), a field emission display (FED) and an organic electro luminescence (EL) display.

Drive method may be roughly divided into a passive matrix drive and an active matrix drive. The passive matrix drive is simple in construction in which voltages are applied between electrodes at intersections of signal electrodes and scanning electrodes divided into columns and rows to make pixels sandwiched therebetween emit light. The passive matrix drive method is used for a small-screen liquid crystal display or an organic EL display. In addition, this drive method is used for PD or FED even in a large screen.

On the other hand, the active matrix drive requires several thin-film transistors (TFTs) and data storage capacitors for each pixel, but is higher in response speed than the passive matrix drive. Further, use of a large screen provides high superiority in driving voltage and energy consumption. A large-screen liquid crystal display or organic EL display uses this drive method.

The need for FPD having larger screen and higher definition is increasing more and more. In PD or FED using passive matrix drive for the larger screen and higher accuracy, the display period of each pixel becomes shorter. Because the time interval before the next display increases, especially in the case of display of a dark moving image, a problem of conspicuous flickering occurs. Solution for such a problem requires to increase the number of times of display per unit time.

On the other hand, the active matrix drive has a problem of blurring of a moving image because each pixel is continued to be on during one scanning period. As one solution of this problem, there is a method of inserting a black indication during intervals between scannings to clearize a moving image. For the larger screen and higher definition, it is necessary to increase the number of display times of black per unit time in the same way.

To solve such a problem of increasing the number of display times per unit time using a display having low display capability per unit time to provide high definition, a drive method has been proposed as described below. For example, this is a case where a video image data of 2n frames/second is displayed with a display resolution of 2n frames/second using a display having display capability of n frames/sec in the case of no split drive.

To solve such a problem, a screen is vertically split into two portions. Specifically, a signal line is divided at an upper half and a lower half of a display screen and each of the upper half and the lower half of the screen is independently driven. In addition, there has been proposed a method of doubling a writing time of each pixel per unit time as compared to a case where a signal line is not divided.

However, the split drive method has a general problem of causing image distortion known as split stripe disturbance at a split portion, which hampers a smooth moving image display. Referring to FIGS. 8A, 8B and 8C, the split stripe disturbance will be described below.

It is assumed that an object captured as a video image data as illustrated in FIG. 8A moves from a position “a” to a position “b” on a screen during one-frame display period. It is assumed that the moving image is displayed on a display vertically split into two portions with regard to a central screen split line as illustrated in FIG. 8B.

FIG. 8B illustrates a state where a video image data at frame I+1 is overwritten from the top of a video image data at frame I in the upper and the lower screen parts. Each portion shown by a broken line in the upper and the lower screen parts is a portion where data is overwritten and a video image data is separated by an amount corresponding to movement of an object, but the portion is sequentially overwritten and therefore the portion visually appears continuous when scanned at high speed.

However, at a position of the screen split line, when writing of a video image data at a new frame begins, a separation occurs in the object by an amount corresponding to movement between the upper and the lower screen parts, and this separation is unchangeable during scanning. Accordingly, when new video image data is sequentially overwritten, the object visually appears to be moving discontinuously. This is a phenomenon called the split stripe disturbance. The split stripe disturbance cannot be solved by a present display method even if scanning is performed at any high speed.

As a method for solving the split stripe disturbance, there has been proposed a system, for example, as disclosed in Japanese Patent Application Laid-Open No. H10-268261. Specifically, as illustrated in FIG. 8C, display is always made, shifted by one frame between the upper and the lower screen parts. In the upper screen part, a video image data at field I+2 is overwritten on a video image data at frame I+1 being displayed. On the other hand, in the lower screen part, a video image data at frame I+1 is overwritten on a video image data at frame I being displayed.

In a scanning portion indicated by a broken line, an object is separated by an amount corresponding to object movement per one frame as in FIG. 8B, but the scanning portion is sequentially overwritten. In the case of high-speed scanning, even the separated portion visually appears continuous. At a screen split position, a video image data of the same frame as frame I+1 is displayed on both the upper and the lower screen parts and therefore the object has no separation therein. This can eliminate image distortion caused by split stripe disturbance.

Referring to FIGS. 9 and 10, a detailed operation of the method shown in FIGS. 8A, 8B and 8C will be described below. First, as illustrated in FIG. 9, a video image signal 25 such as a video signal is converted into a digital data of each pixel by an A/D converter 26. The digital video image data is switched with a change-over switch 27 for each frame and is alternately stored in two frame memories 28, 29.

Each of the frame memories 28, 29 is correspondingly divided into an upper screen part 31 and a lower screen part 32 of a display screen subjected to split driving of 28a, 28b and 29a, 29b. Switched with a switch 30, a video image data which has been recorded is distributed to the upper screen part 31 and the lower screen part 32 subjected to two-split driving, and overwriting display of the data is made by a driving circuit (not shown).

The display performance of a display without split implemented is given as n frames/sec herein. The video image signal 25 is a video image data of 2n frames/sec. In this example, the writing rate for a video image data into a frame memory is 2n frames/sec, while the read-out rate for a video image data from a frame memory is n frames/sec. Specifically, this method can display a video image data of 2n frames/sec because of two-split system even if the writing rate of each pixel of the display is low.

In FIG. 9, the change-over switch 27 is connected to the frame memory 29 and a video image data at frame I+3 is being overwritten on the frame memory 29 in which a video image data of frame I+1 frame has been stored. In the frame memory 28, a video image data of frame I+2 has been already stored.

In the reading change-over switch 30, the data region 28a in the upper screen part of the frame memory 28 is connected to the upper screen part 31 of the screen display, and the data region 29b in the lower screen part of the frame memory 29 is connected to the lower screen part 32 of the display screen. Under this condition, in the upper screen part 31 of the display screen, a video image data of frame I+2 is overwritten on a video image data of frame I+1 and in the lower screen part 32, a video image data of frame I+1 frame is overwritten on a video image data of frame I. Specifically, a display as illustrated in FIG. 8C is made.

Next, after a video image data at frame I+3 is stored in the frame memory 29, the recording change-over switch 27 is switched to the frame memory 28 as illustrated in FIG. 10. Then, a video image data of frame I+4 is overwritten on a video image data of frame I+2.

In the reading change-over switch 30, the data region 28b in the lower screen part of the frame memory 28 is connected to the lower screen part 32 of the display screen, and the data region 29a in the upper screen part of the frame memory 29 is connected to the upper screen part 31 of the display screen. Under this condition, in the upper screen part 31 of the display screen, a video image data of frame I+3 is overwritten on a video image data of frame I+2. In the lower screen part 32, a video screen data of frame I+2 is overwritten on a video image data of frame I+1. The display illustrated in FIG. 9 shows that a video image data for one frame is overwritten in each region.

In the driving method described above, a video image data can be sequentially displayed without an object having a separation visible to the human eye. However, in both of FIGS. 9 and 10, 3-frame data is concurrently displayed on a display screen. In a display not vertically split into two portions, an image is rewritten with one scanning line and therefore only a video image data for two frames is concurrently displayed on a screen. Display of a moving image on a vertical two-split screen is achieved in a different way from a conventional non-split screen.

Accordingly, this method has a disadvantage of degradation in display resolution compared to that of a non-split screen. Specifically, display performance can be doubled by split drive using a display having lower display performance, but actual display resolution is inferior to that of a display having twofold display performance.

In that case, specifically, when display is made on CRT having high display quality even with a display having a large screen, a moving image is displayed significantly smoothly to the human eye at a display rate of 60 frames/sec. However, PD or FED often has flickers at a display rate of 60 frames/sec and a liquid crystal display or an organic electro luminescence (EL) display has a problem of images being blurred.

### SUMMARY OF THE INVENTION

It is an aspect of the present invention to provide a display apparatus for displaying a video image data on a display having an upper display part and a lower display part, including a frame memory for storing therein the video image data at a storing tate of N frames/sec and supplying the stored video image data twice to each of the upper display part and the lower display part to write the video image data into the display at a rate of 2N frames/sec, wherein while the video image data of the (I+1)th frame are written in the upper display part as the first time, the video image data of Ith frame which precedes by one frame to the (I+1)th frame is written in the lower display part as the second time and while the video image data of (I+1) the frame are written in the upper display part as the second time, the video image data of the (I+1)th frame are written in the lower display part as the first time.

The display apparatus according to the present invention can attain 2N times/sec as the number of times of writing a video image data of N frames/sec into each pixel with maintaining display resolution of N frames/sec maintained, in a display screen performing two-split drive. Accordingly, the display apparatus can suppress flickers even in use of PD or FED and suppress image blurring in use of a liquid crystal display or an organic electro luminescence (EL) display.

Further features of the present invention will become apparent from the following description of exemplary embodiments with reference to the attached drawings.

### BRIEF DESCRIPTION OF THE DRAWINGS

FIG. 1 is a block diagram illustrating one embodiment of a display apparatus according to the present invention.

FIGS. 2A and 2B are timing charts illustrating a display system according to the present invention.

FIG. 3 is a view illustrating a state at a time T1 of a display apparatus according to the present invention.

FIG. 4 is a view illustrating a state at a time T2 of a display apparatus according to the present invention.

FIG. 5 is a view illustrating a state at a time T3 of a display apparatus according to the present invention.

FIG. 6 is a view illustrating a state at a time T4 of a display apparatus according to the present invention.

FIGS. 7A, 7B, 7C and 7D are timing charts illustrating a relationship between a frame data and a display data of a display apparatus according to the present invention, respectively.

FIGS. 8A, 8B and 8C are views illustrating split stripe disturbance, respectively.

FIG. 9 is a view illustrating a conventional system solving split stripe disturbance.

FIG. 10 is a view illustrating a conventional system solving split stripe disturbance.

### DESCRIPTION OF THE EMBODIMENTS

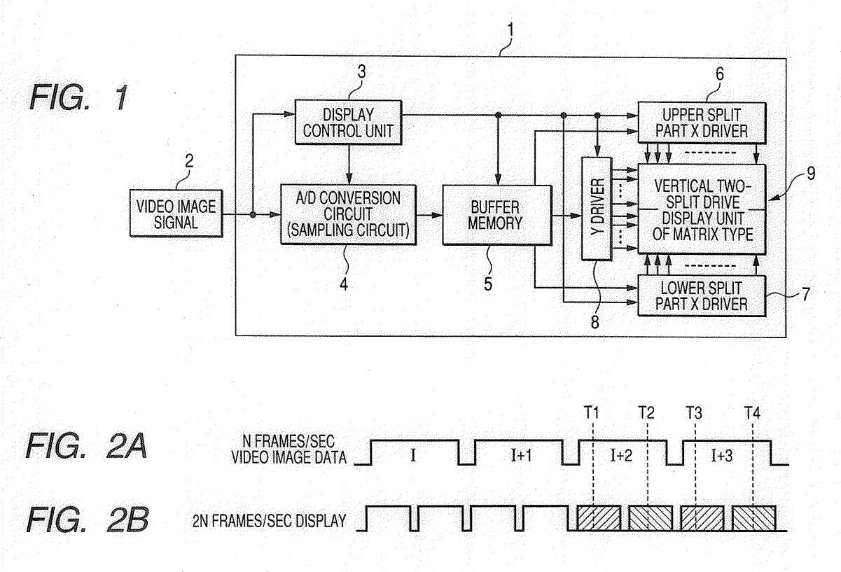

Next, referring to the drawings, exemplary embodiments of the present invention will be described below. FIG. 1 is a block diagram illustrating one embodiment of a display apparatus according to the present invention. A display apparatus 1 includes at least a display control unit 3, and a block 4 having functions of an A/D conversion circuit and a sampling circuit. The block 4 is referred to as an A/D conversion circuit 4 for simple description.

The display apparatus further includes a buffer memory 5, an upper X driver 6, a lower X driver 7, a Y driver 8 and a display unit 9. The display unit 9 is a vertical two-split drive display unit in which pixels including a plurality of light emitting element and drive circuits thereof are matrix-arranged. The display unit 9 may use PD, FED, liquid crystal display or organic electro luminescence (EL) display.

The display control unit 3 is a control circuit for controlling each part of the apparatus and performs control for converting a video image signal 2 input from the outside into a digital data for each pixel. In addition, the display control unit controls a series of operations of dividing a signal line into an upper half and a lower half of a display screen in a matrix manner and independently driving the upper half and the lower half of each screen to be displayed on the display unit 9.

The video image signal 2 may be either of an analog signal such as a video signal, or a digital signal such as DVD signal. The video image signal 2, when input into the display apparatus 1, is converted into a display data of each pixel by the A/D conversion circuit 4 according to an instruction from the display control unit 3. The display data of each pixel is stored in the buffer memory 5.

On the other hand, the display data of each pixel stored in the buffer memory 5 is read out according to an instruction of the display control unit 3, and vertically-split two independent scanning are performed on the display unit 9 by the upper X driver 6, lower X driver and Y driver 8. With this scanning, image display is attained. The upper X driver 6 performs scanning in a horizontal direction of the upper split screen part and the lower X driver 7 performs scanning in a horizontal direction of the lower screen part. The Y driver 8 performs scanning in a vertical direction of the display screen.

FIGS. 2A and 2B are timing charts illustrating a display system of the present invention. FIG. 2A illustrates a flow of a video image data of N frames/sec, in which a video image data for one frame is shown as one square signal. It is assumed that an I+3th frame data has flowed from Ith frame.

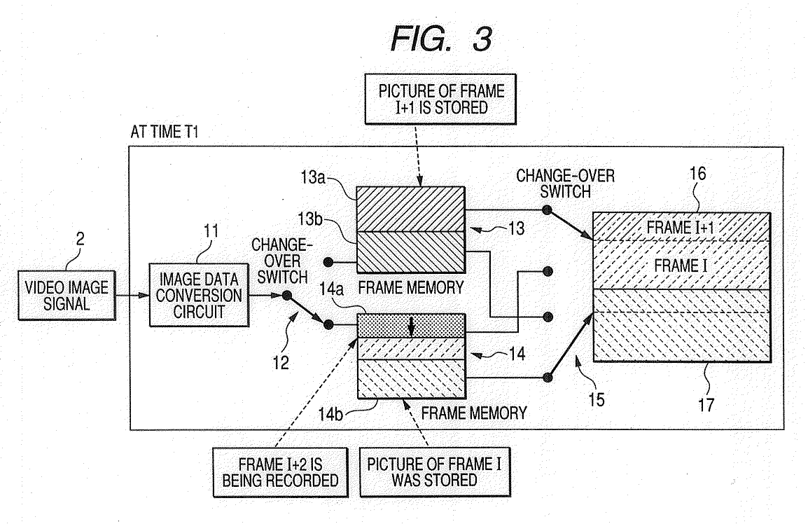

FIG. 2B illustrates a display period for performing display of 2N frames/sec twice as large as FIG. 2A. One square signal shows one scanning period. Referring to FIGS. 3 to 6, a flow of a video image data in the display apparatus 1 at each time of T1 to T4 will be described in detail. The corresponding relationship between components in FIG. 1 and components in FIGS. 3 to 6 will be described later.

First, as illustrated in FIGS. 3 to 6, a video image signal 10 is converted into a digital data of each pixel by a pixel data conversion circuit 11 having functions of an A/D conversion circuit and a sampling circuit. The converted digital video image data is switched by a change-over switch 12 for every frame to be alternately stored in a first frame memory 13 and a second frame memory 14. That is, a video image data of N frames/sec is stored in the first and the second frame memories in a change-over manner for each frame.

The first frame memory 13 and the second frame memory 14 are divided into 13a, 13b and 14a, 14b respectively, and 13a and 14a each denote a data storage area of a video image data for the upper screen part of one frame. Reference characters 13b and 14b refer to a data storage area of a video image data for the lower screen part corresponding to one frame, respectively. Each of video image data can be read out independently.

Specifically, upper display data and lower display data are independently read out from the first and the second frame memories 13, 14, respectively. In the first and the second frame memories 13, 14, the writing rate for a video image data is the same as the read-out rate for the data.

Further, by changing over a switch 15, the video image data which has been recorded in either of 13a or 14a, or either of 13b or 14b can be transmitted to each of an upper screen part 16 and a lower screen part 17 of the display screen subjected to two-split drive. Specifically, the video image data stored in the first and the second frame memories are independently switched as an upper display data and a lower display data to be supplied to the upper display part and the lower display part. Overwriting display of data is thus made by a drive circuit (not illustrated).

The change-over switches 12, 15 and the frame memories 13, 14 correspond to the buffer memory 5 illustrated in FIG. 1, which is not repeated in FIG. 3. The display control unit 3 controls the switches 12, 15, while FIG. 3 omits such control.

The upper screen part 16 and the lower screen part 17 correspond to the upper X driver 6, the lower X driver 7, the Y driver 8 and the display unit 9 shown in FIG. 1. A divided video image is displayed by driving the upper X driver 6, the lower X driver 7 and the Y driver 8 according to a control signal supplied from the display control unit 3.

The display performance of the display not being split is N frames/sec. The video image signal 2 is a video image data of N frames/sec. In the present invention, the writing rate of a video image data into a frame memory is N frames/sec, while the read-out rate of a video image data from a frame memory is N frames/sec. By two-split method unlike an example of a conventional art as described above, the number of times of writing into each pixel of a display per unit time is 2N times/sec twice as large as a conventional one.

First, FIG. 3 illustrates a state at a time T1 in FIGS. 2A and 2B. In FIG. 3, the change-over switch 12 is connected to the first frame memory 14, and an upper screen part of a video image data of frame I+2 is being overwritten on the second frame memory 14 in which a video image data of frame I has been stored. At this time, a video image data at frame I+1 has been already stored in the first frame memory 13.

On the other hand, in the reading change-over switch 15, the data storage area 13a of the upper screen part of the first frame memory 13 is connected to the upper screen part 16 of the display screen, and the data storage area 14b of the lower screen part 17 of the second frame memory 14 is connected to the lower screen part 17 of the display screen. Under this condition, in the upper screen part 16 of the display screen, a video image data of frame I+1 is overwritten on a video image data of frame I and, in the lower screen part 17, a video image data of frame I is overwritten on a video image data of frame I. The display has been made corresponds to two frames.

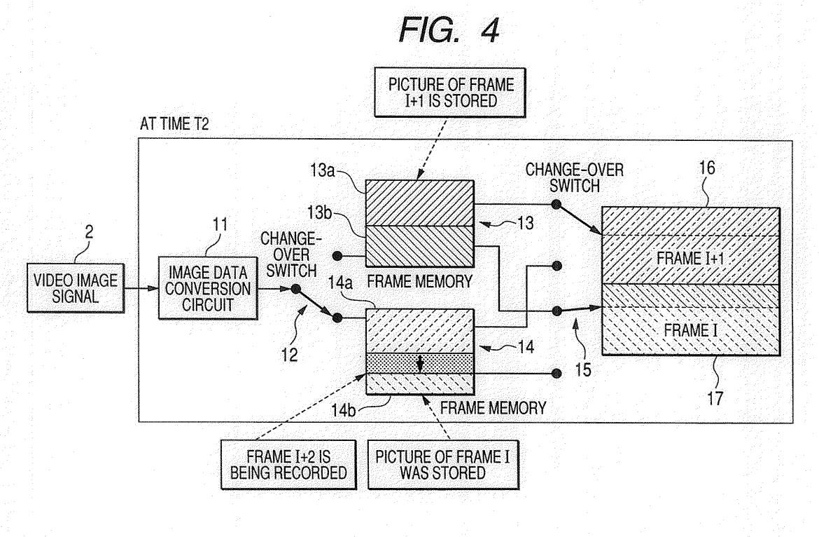

FIG. 4 illustrates a state at a time T2. In FIG. 4, the change-over switch 12 is connected to the second frame memory 14, and a lower screen part of a video image data of frame I+2 is being overwritten on the second frame memory 14 in which a video image data of frame I has been stored. A video image data of frame I+1 has been already stored in the first frame memory 13.

In the reading change-over switch 15, the data storage area 13a of the upper screen part of the first frame memory 13 is connected to the upper screen part 16 of the display screen, and the data storage area 13b of the lower screen part of the first frame memory 13 is connected to the lower screen part 17 of the display screen. Under this condition, in the upper screen part 16, a video image data of frame I+1 is overwritten on a video image data of frame I+1 and in the lower screen part 17, a video image data of frame I+1 is overwritten on a video image data of frame I. The display which has been made in the same way corresponds to two frames.

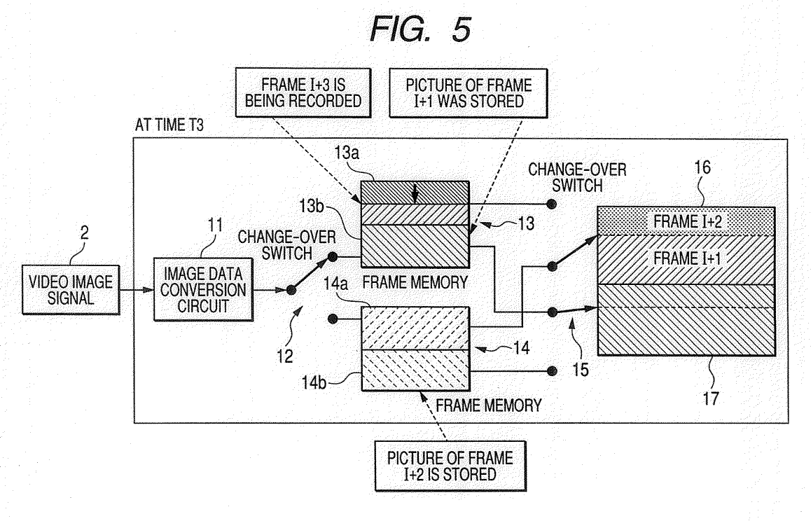

FIG. 5 illustrates a state at a time T3. In FIG. 5, the change-over switch 12 is switched to the first frame memory 13, and an upper screen part of a video image data of frame I+3 is being overwritten on the first frame memory 13 in which a video image data of frame I+1 has been stored. At this time, a video image data of frame I+2 has been already stored in the second frame memory 13.

By the reading change-over switch 15, the data storage area 14a of the upper screen part of the second frame memory 14 is connected to the upper screen part 16, and the data storage area 13b of the lower screen part of the first frame memory 13 is connected to the lower screen part 17. Under this condition, in the upper screen part 16, a video image data of frame I+2 is overwritten on a video image data of frame I+1 and in the lower screen part 17, a video image data of frame I+1 is overwritten on a video image data of frame I+1. The display corresponds to data of two frames.

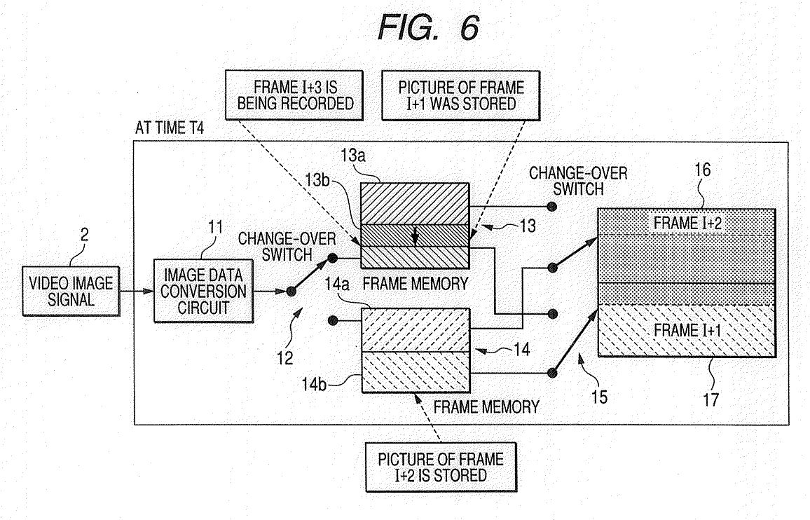

Finally, FIG. 6 illustrates a state at a time T4. In FIG. 6, the change-over switch 12 is connected to the first frame memory 13, and a lower screen part of a video image data at frame I+3 is being overwritten on the first frame memory 13 in which a video image data of frame I+1 has been stored. A video image data of frame I+2 is still already stored in the second frame memory 14.

By the reading change-over switch 15, the data storage area 14a of the upper screen part of the second frame memory 14 still remains being connected to the upper screen part 16 of the display screen, and the data storage area 14b of the lower screen part of the second frame memory 14 is connected to the lower screen part 17. Under this condition, in the upper screen part 16, a video image data of frame I+2 is overwritten on a video image data of frame I+2 and in the lower screen part 17, a video image data of frame I+2 is overwritten on a video image data at frame I+1. The display which has been made in the same way corresponds to two frames.

In a flow of the data illustrated in FIGS. 3 to 6, a video image data of N frames/sec for two frames is stored in a frame memory and is further read out for split display. A look at an upper screen part 16 and a lower screen part 17 of the two-split display in FIGS. 3 to 6 shows that a new video image data for two frames is displayed and a separation in an object appears at one position in the same way as in the case of display of N frames/sec using a display performing no split display. Specifically, with the display resolution of N frames/sec being retained, the number of times of writing a video image data into each pixel can be doubled, that is, 2N times/sec can be obtained.

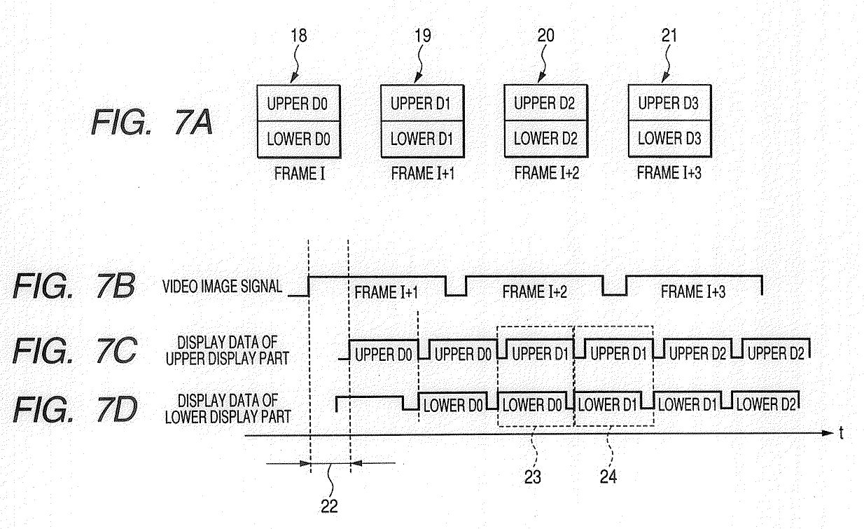

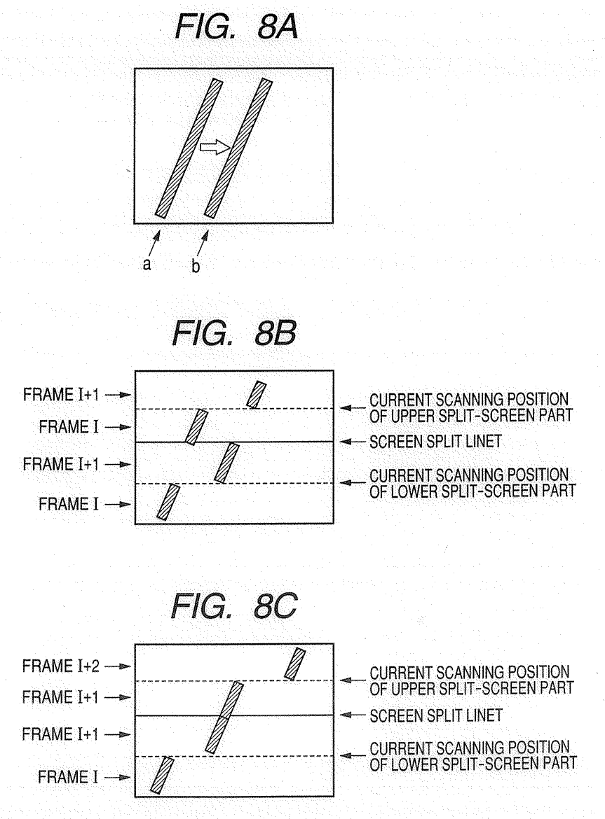

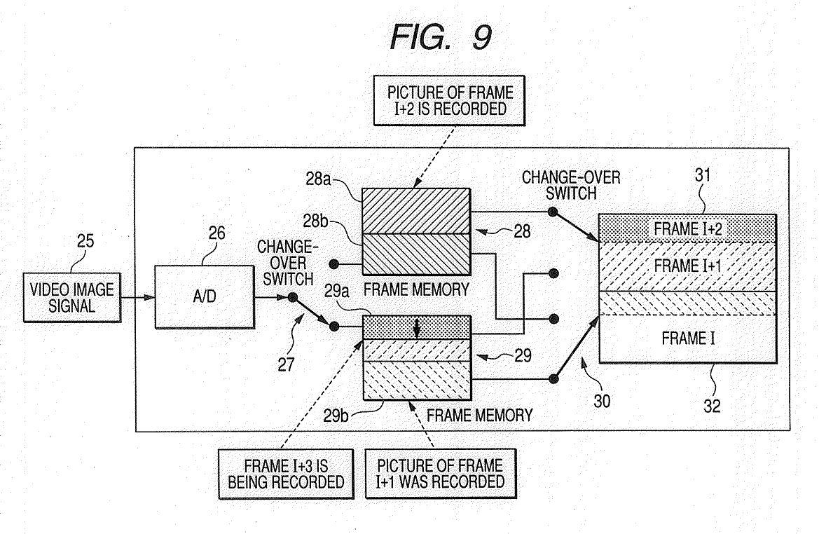

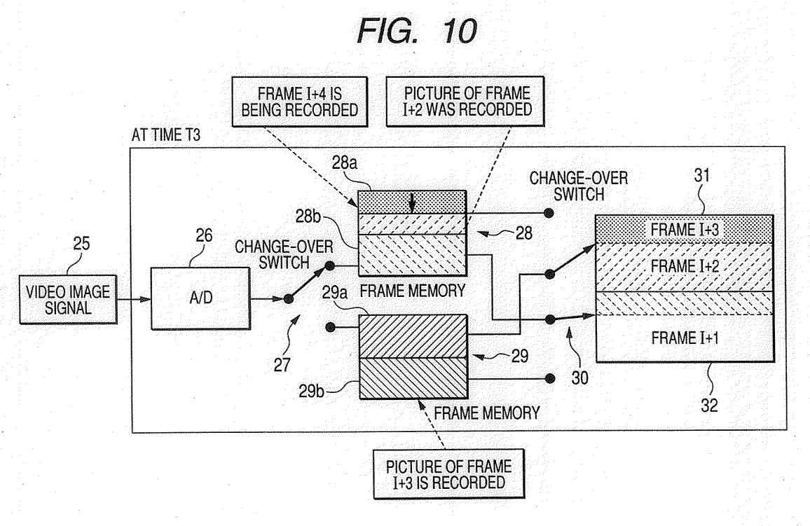

FIG. 7A is a timing chart illustrating a relationship between a frame data and a display data of a flow of video image data illustrated in FIGS. 3 to 6. Reference numerals 18 to 21 denote frame I to frame I+3, each of which includes an upper display data and a lower display data of DO upper and DO lower, D1 upper and D1 lower, D2 upper and D2 lower, and D3 upper and D3 lower.

FIG. 7B shows a video signal. A display data of the upper display part in FIG. 7C is transmitted to the upper display part (the upper screen part 16) and is displayed on the upper display part after a delay for a fixed period indicated by reference numeral 22 from the timing when a video image signal is transmitted. A display data of the lower display part in FIG. 7D is transmitted to the lower display part (a lower screen part 17) and is displayed on the lower display part.

In view of scanning continuity at a boundary between the upper display part and the lower display part, preferably, scanning of the lower display part may be started at the highest position of the lower display part in subsequent to completion of scanning of the lowest position of the upper display part.

The delay time of reference numeral 22 is a period specific to the apparatus, which is generated by the pixel data conversion circuit 11 or by writing or reading data of the first frame memory 13 and the second frame memory 14.

In the present invention, as shown by a broken line 23 in FIGS. 7C and 7D, while an upper display data of frame I+1 is being displayed on the upper display part, a first scanning for displaying a lower display data of frame I at one frame before on a lower display part is performed. In subsequent to the first scanning, as shown by a broken line 24, while an upper display data of frame I+1 is being displayed on the upper display part, a second scanning for displaying a lower display data of the same frame I+1 on the lower display part is performed. The first scanning and the second scanning are repeated. The present invention can be implemented by such scanning without limitation to configurations as illustrated in FIGS. 3 to 6.

As described above, the display apparatus according to the present invention displays a video image data of N frames/sec on the display unit 9 split into the upper screen part 16 and the lower screen part 17 at a display period of 2N frames/sec. In addition, the display apparatus also includes a frame memory for writing a video image data of N frames/sec into the display unit at 2N times/sec and supplying the written video image data to the upper display part and the lower display part as an upper display data and a lower display data.

While an upper display data of a video image data of I+1th frame from a frame memory is being scanned in the upper screen part 16, the first scanning is performed on the lower display part. The first scanning is a method for concurrently scanning a lower display data of a video image data of frame I preceding by one frame to I+1th frame. In subsequent to the first scanning, while an upper display data of a video image data of the I+1st frame from a frame memory is being scanned in the upper display part, the second scanning for concurrently scanning a lower display data of a video image data of the I+1th frame is performed on the lower display part.

The display method for the present invention is performed as follows: While an upper display data of a video image data of I+1th frame from a frame memory is being scanned in the upper display part, a first step is performed on the lower display part. The first step is a process for concurrently scanning a lower display data of a video image data of frame I preceding by one frame to I+1th frame. In subsequent to the first step, while an upper display data of a video image data of the I+1th frame from a frame memory is being scanned on the upper display part, a second step for concurrently scanning a lower display data of a video image data at the I+1st frame is performed for the lower display part.

The display apparatus according to the present invention can increase the number of times of writing a video image signal of N frame into each pixel to 2N times/sec while retaining display resolution of N frames/sec. Specifically, scanning according to the present invention can increase the number of times of writing a video image data of 60 frames/sec into each pixel to 120 times/sec while retaining display resolution of 60 frames/sec.

Hence PD or FED can suppress generation of flickers and a liquid crystal display or an organic electro luminescence (EL) display can suppress image blurring. It becomes obvious that with an advance of higher definition, the present invention can be applied to a case where the number of times of writing a video image data of 120 frames/sec in each pixel is increased to 240 times/sec while display resolution of 120 frames/sec is being retained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-169074, filed Jun. 27, 2007, which is hereby incorporated by reference herein in its entirety.

What is claimed is:

1. A display apparatus for displaying a video image data on a display having an upper display part and a lower display part, comprising:
a frame memory for storing therein the video image data at a storing rate of N frames/sec and supplying the stored video image data twice to each of the upper display part and the lower display part to write the video image data into the display at a rate of 2N frames/sec,
wherein while the video image data of the (I+1)th frame are written in the upper display part as the first time, the video image data of Ith frame which precedes by one frame to the (I+1)th frame is written in the lower display part as the second time, and while the video image data of (I+1)th frame are written in the upper display part as the second time, the video image data of the (I+1)th frame are written in the lower display part as the first time.

2. The display apparatus according to claim 1, wherein the frame memory includes a first and a second frame memories in each of which storing rate for the video image data is the same as a read-out rate for the video image data.

3. The display apparatus according to claim 2, wherein each of the first and the second frame memories are so configured that the upper and the lower display data are independently read-out.

4. The display apparatus according to claim 2, wherein the video image data are stored in the first and the second frame memories alternately, and the video image data in the first and the second frame memories are independently read-out and supplied to the upper display part and the lower display part alternately.

5. The display apparatus according to claim 1, wherein writing the video image data into the lower screen part is started at the highest position of the lower display part in subsequent to completion of writing the video image data into the lowest position of the upper display part.

6. A display method for the display apparatus for displaying a video image data on display having an upper display part and a lower display part the apparatus including:
a frame memory for storing the video image data at a rate of N frames/sec and for supplying the stored video image data twice to each of the upper display part and the lower display part to write the video image data into the display at a rate of 2N frames/sec,
the method comprising:
a first step in which, while the video image data of the (I+1)th frame from the frame memory are written into the upper display part as the first time, the video image data of the Ith frame which precedes by one frame to the (I+1)th frame are written into the lower display part as the second time, and
a second step in which, while the video image data of the (I+1)th frame supplied from the frame memory are written into the upper display part as the second time, the video image data of the (I+1)th frame are written into the lower display part as the first time.
